(19) United States
(12) Patent Application Publication
(10) Pub. No.: US 2026/0084656 A1
(43) Pub. Date: Mar. 26, 2026

(54) VEHICLE VENT PATCH CLEANING SYSTEMS

(71) Applicant: FORD GLOBAL TECHNOLOGIES, LLC, Dearborn, MI (US)

(72) Inventors: Michael Robertson, West Bloomfield, MI (US); Segundo Baldovino, Novi, MI (US); Venkatesh Krishnan, Canton, MI (US); Aaron Bradley Johnson, Allen Park, MI (US)

(21) Appl. No.: 18/897,799

(22) Filed: Sep. 26, 2024

(51) Int. Cl. B60S 1/60; B08B 3/02; B08B 5/02

(52) U.S. Cl. CPC B60S 1/603; B08B 3/02; B08B 5/02

(57) ABSTRACT

Vent patch cleaning systems are provided for motor vehicles. The vent patch cleaning systems may be configured for cleaning a vent patch of a vehicle component, thereby restoring air circulation through the vehicle component and reducing condensation build-up. An exemplary vent patch cleaning system may direct a fluid (e.g., washer fluid, airflow, or both) onto the vent patch for removing dirt and debris that could otherwise inhibit proper air circulation through the vehicle component.

### TECHNICAL FIELD

This disclosure relates generally to motor vehicles, and more particularly to cleaning systems for cleaning vent patches of vehicle components.

### BACKGROUND

Vehicle exterior lighting systems include front and rear lamp assemblies that are configured to illuminate the surrounding areas of the vehicle. These front and rear lamp assemblies may naturally experience moisture, heat, and condensation conditions.

### SUMMARY

A motor vehicle according to an exemplary aspect of the present disclosure includes, among other things, a vehicle component including a vent patch, and a vent patch cleaning system arranged to selectively direct a fluid toward the vent patch for cleaning the vent patch.

In a further non-limiting embodiment of the foregoing motor vehicle, the vehicle component is a lamp assembly of an exterior lighting system of the motor vehicle.

In a further non-limiting embodiment of either of the foregoing motor vehicles, the vent patch cleaning system includes a sprayer unit mounted to a housing of the vehicle component.

In a further non-limiting embodiment of any of the foregoing motor vehicles, the sprayer unit includes a first nozzle arranged to selectively direct a pressurized washer fluid toward the vent patch.

In a further non-limiting embodiment of any of the foregoing motor vehicles, the sprayer unit is fluidly connected to a washer fluid reservoir by a hose.

In a further non-limiting embodiment of any of the foregoing motor vehicles, the sprayer unit includes a second nozzle arranged to selectively direct a pressurized airflow toward the vent patch.

In a further non-limiting embodiment of any of the foregoing motor vehicles, the second nozzle is operably connected to a fan housed inside the sprayer unit.

In a further non-limiting embodiment of any of the foregoing motor vehicles, the vent patch cleaning system includes a sensor system configured to sense a parameter associated with an interior environment of the vehicle component.

In a further non-limiting embodiment of any of the foregoing motor vehicles, a controller operably connects to the sensor system and is programmed to selectively command the vent patch cleaning system to direct the fluid toward the vent patch based on sensor data from the sensor system.

In a further non-limiting embodiment of any of the foregoing motor vehicles, the sensor data includes information related to a humidity, an airflow, or a pressure within the interior environment.

In a further non-limiting embodiment of any of the foregoing motor vehicles, the vent patch cleaning system includes a spraying unit, a washer fluid reservoir, and an electric air pump.

In a further non-limiting embodiment of any of the foregoing motor vehicles, the vent patch cleaning system includes an air blower, the vent patch, and a second vent patch.

In a further non-limiting embodiment of any of the foregoing motor vehicles, the vent patch cleaning system includes an air duct formed within a housing of the vehicle component.

In a further non-limiting embodiment of any of the foregoing motor vehicles, the air duct includes an inlet configured to receive a forced airflow extracted from a headwind of the motor vehicle and an outlet configured to direct the forced airflow onto the vent patch.

A vent patch cleaning system for a motor vehicle according to another exemplary aspect of the present disclosure includes, among other things, a washer fluid reservoir configured to hold a washer fluid, and a sprayer unit configured to receive the washer fluid from the washer fluid reservoir. A first nozzle of the sprayer unit is configured to receive the washer fluid and deliver a pressurized washer fluid onto a vent patch for cleaning the vent patch.

In a further non-limiting embodiment of the foregoing vent patch cleaning system, a second nozzle of the sprayer unit is configured to deliver a pressurized airflow onto the vent patch for drying the vent patch.

In a further non-limiting embodiment of either of the foregoing vent patch cleaning systems, the second nozzle is operably connected to a fan housed inside the sprayer unit.

In a further non-limiting embodiment of any of the foregoing vent patch cleaning systems, a sensor system is configured to sense a parameter associated with an interior environment of a vehicle component to which the vent patch is attached.

In a further non-limiting embodiment of any of the foregoing vent patch cleaning systems, a controller operably connected to the sensor system is programmed to selectively command the vent patch cleaning system to perform a vent patch cleaning operation based on sensor data from the sensor system.

In a further non-limiting embodiment of any of the foregoing vent patch cleaning systems, during a first step of the vent patch cleaning operation, the controller is programmed to command the vent patch cleaning system to direct the pressurized washer fluid onto the vent patch for cleaning the vent patch, and during a second step of the vent patch cleaning operation, the controller is programmed to command the vent patch cleaning system to direct the pressurized airflow onto the vent patch for drying the vent patch.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a motor vehicle equipped with an exterior lighting system.

FIG. 2 illustrates a lamp assembly of the motor vehicle of FIG. 1.

FIG. 3 illustrates a vent patch cleaning system for cleaning a vent patch of a vehicle component.

FIG. 4 is a cross-sectional view of the vent patch cleaning system of FIG. 3.

FIG. 5 schematically illustrates exemplary cleaning operations of a vent patch cleaning system.

FIG. 6 illustrates a sprayer unit of a vent patch cleaning system.

FIGS. 7 and 8 schematically illustrate another exemplary vent patch cleaning system.

FIG. 9 schematically illustrate another exemplary vent patch cleaning system.

FIGS. 10 and 11 schematically illustrate yet another exemplary vent patch cleaning system.

### DETAILED DESCRIPTION

This disclosure describes vent patch cleaning systems for motor vehicles. The vent patch cleaning systems may be configured for cleaning a vent patch of a vehicle component, thereby restoring air circulation through the vehicle component and reducing condensation build-up. An exemplary vent patch cleaning system may direct a fluid (e.g., washer fluid, airflow, or both) onto the vent patch for removing dirt and debris that could otherwise inhibit proper air circulation through the vehicle component. These and other features of this disclosure are discussed in greater detail in the following paragraphs of this detailed description.

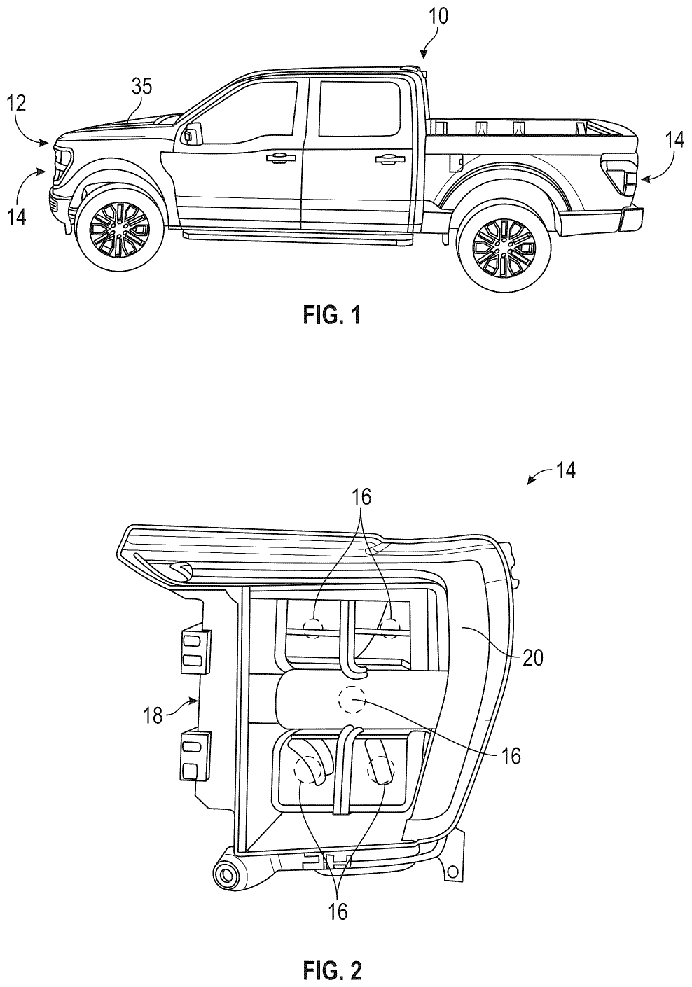

FIG. 1 schematically illustrates a motor vehicle 10 (hereinafter referred to simply as “the vehicle”) that includes an exterior lighting system 12. The vehicle 10 could be a pickup truck, a car, a van, a sport utility vehicle, or any other type of vehicle. Additionally, the vehicle 10 could be a conventional, internal combustion engine powered vehicle, a hybrid or plug-in hybrid vehicle, a battery electric vehicle, an autonomous vehicle (i.e., a driverless vehicle), etc.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component or system.

The exterior lighting system 12 may be configured to illuminate surrounding areas of the vehicle 10 and includes at least one lamp assembly 14. In an exemplary embodiment, the exterior lighting system 12 includes four lamp assemblies 14 (e.g., two headlamp assemblies and two taillamp assemblies). However, the exterior lighting system 12 could include any combination of front, rear, and/or side lamp assemblies for illuminating the surrounding areas of the vehicle 10.

FIG. 2 further illustrates one of the lamp assemblies 14 of the vehicle 10 of FIG. 1. The lamp assembly 14 may include one or more light sources 16 (e.g., light-emitting diodes) enclosed within a housing 18 by an outer lens 20. The specific configuration of each of the light sources 16, the housing 18, and the outer lens 20 is not intended to limit this disclosure. It should therefore be appreciated that the lamp assembly 14 could embody any of a variety of sizes, shapes, configurations, etc.

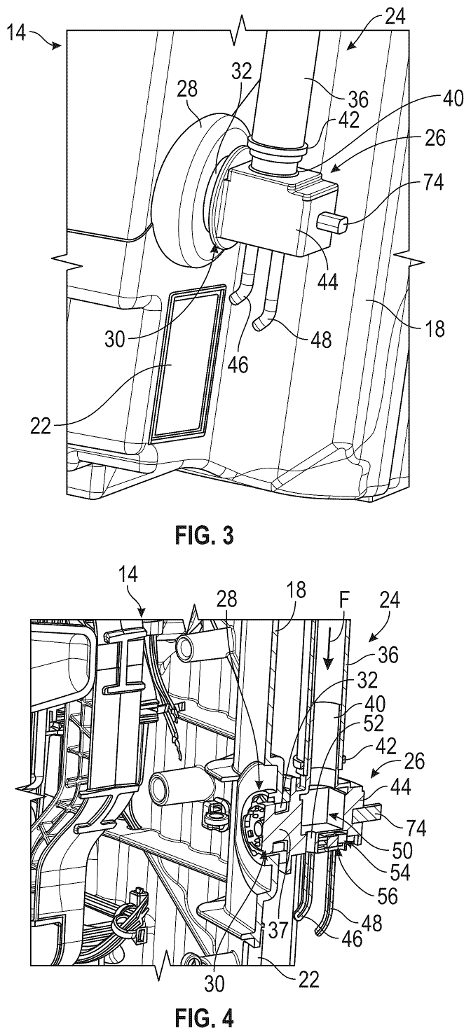

A vent patch 22 (see FIG. 3) may be mounted to the housing 18, such as at a rear exterior surface, for example. The vent patch 22 functions to allow airflow circulation between an interior of the lamp assembly 14 and its exterior environment while blocking ingress of contaminants such as dirt, debris, moisture, etc. The vent patch 22 promotes pressure and environmental equalization, which can reduce condensation build-up within the interior of the lamp assembly 14.

The lamp assembly 14 is an exemplary type of vehicle component that can include a vent patch. However, other vehicle components of the vehicle 10 could require the use of a vent patch for achieving proper functionality. The teachings of this disclosure could therefore extend to any vehicle component that utilizes a vent patch for air circulation and/or pressure equalization.

Due to its exterior mounting location, the vent patch 22 is exposed to environmental elements. Over time, dirt, debris, and/or other contaminants can accumulate on the vent patch 22, thereby reducing its ability to provide proper airflow circulation between the interior of the lamp assembly 14 and its exterior environment. In some instances, contaminant build-up can become so significant that naturally occurring condensation is prevented from escaping the interior of the lamp assembly 14 through the vent patch 22. Increased interior condensation can reduce the ability of the lamp assembly 14 to properly illuminate the surrounding areas of the vehicle 10. This disclosure is therefore directed to vent patch cleaning systems for cleaning the vent patch 22 in order to restore proper airflow circulation through the lamp assembly 14 (or any other vehicle component that utilizes a vent patch).

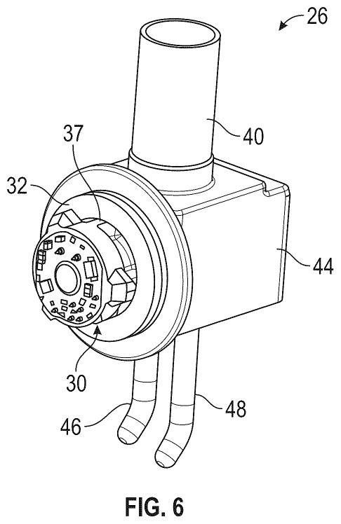

FIGS. 3, 4, 5, and 6 illustrate features associated with an exemplary vent patch cleaning system 24 designed for cleaning a vent patch 22 of a vehicle component, such as the lamp assembly 14, for example. The vent patch 22 may be mounted to any exterior surface of the housing 18 for allowing airflow circulation between an interior and exterior of the housing 18.

The cleaning system 24 may include a sprayer unit 26 that is mountable within a socket 28 of the housing 18. The sprayer unit 26 may include a mount 30 having a twist-in-place design. For example, the mount 30 may be positioned within an opening provided by the socket 28 of the housing 18 and then rotated to secure the sprayer unit 26 to the housing 18. However, the mount 30 could include other configurations, and thus the twist-in-place design is not intended to limit this disclosure.

A seal 32 may be arranged to seal an interface between the sprayer unit 26 and the socket 28. The seal 32 may be received around a neck 37 of the mount 30, for example.

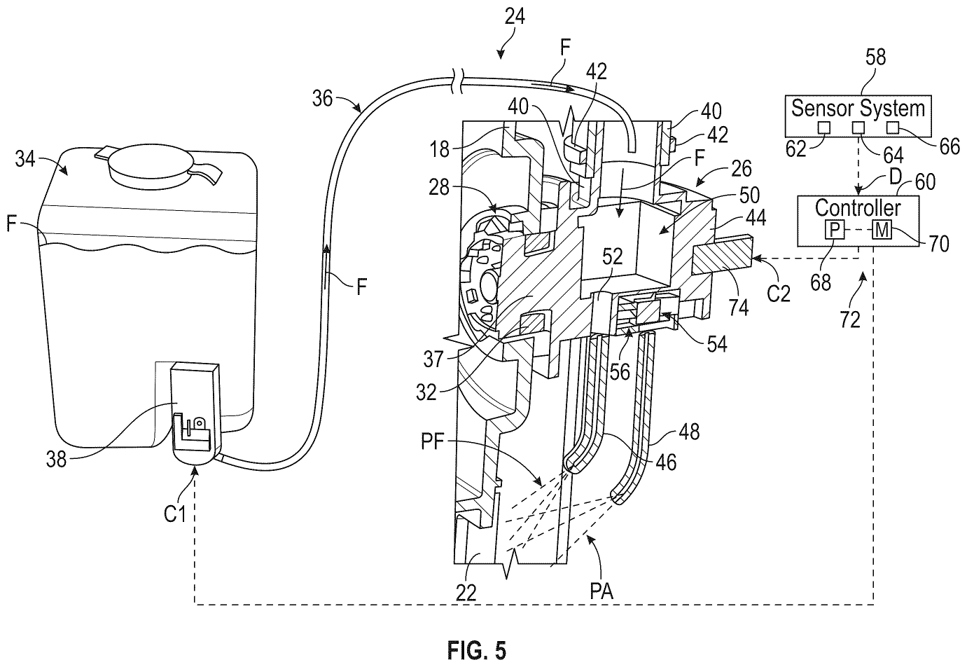

The vent patch cleaning system 24 may additionally include a washer fluid reservoir 34 (see FIG. 5) and a hose 36 that fluidly connects the sprayer unit 26 to the washer fluid reservoir 34. The washer fluid reservoir 34 may store a washer fluid F that can be selectively delivered to the sprayer unit 26 and then subsequently sprayed onto the vent patch 22 for cleaning the vent patch 22. The washer fluid F may be water or water mixed with a suitable cleaning solution, for example.

The hose 36 may be connected at one end to a pump 38 of the washer fluid reservoir 34 and at an opposite end to an inlet tube 40 of the sprayer unit 26. The hose 36 may be connected to the inlet tube 40 by a ring clamp 42, for example. When activated, the pump 38 may deliver the washer fluid F from the washer fluid reservoir 34 to the sprayer unit 26.

The washer fluid reservoir 34 may be mounted beneath a hood 35 (see FIG. 1) of the vehicle 10 (e.g., within an engine compartment or frunk). However, the mounting location of the washer fluid reservoir 34 could vary and is thus not intended to limit this disclosure. In an embodiment, the washer fluid reservoir 34 is a dedicated reservoir used solely to supply the washer fluid F to the sprayer unit 26. In another embodiment, the washer fluid reservoir 34 is equipped to supply the washer fluid F for cleaning other vehicle components in addition to the vent patch 22, including but not limited to windows, cameras, sensors, etc. In yet another embodiment, the washer fluid reservoir 34 may include multiple separated reservoirs that can hold different types of washer fluids.

The sprayer unit 26 may include a main housing 44. The mount 30 and the inlet tube 40 may protrude outwardly from the main housing 44. In an embodiment, the main housing 44, the mount 30, and the inlet tube 40 are integrated together (e.g., molded together) to provide a unitary body of the sprayer unit 26.

The sprayer unit 26 may further include a first nozzle 46 and a second nozzle 48. The first nozzle 46 and the second nozzle 48 may project outwardly from the main housing 44 and may each be configured to direct a pressurized fluid onto a surface of the vent patch 22 that requires cleaning.

The first nozzle 46 may be fluidly connected to an interior reservoir 50 of the main housing 44 through a fluid port 52. The inlet tube 40 may also be fluidly connected to the interior reservoir 50 and can thus selectively deliver the washer fluid F received from the washer fluid reservoir 34 to the interior reservoir 50. The interior reservoir 50 could be sized to accommodate any desired volume of the washer fluid F. Washer fluid F from the interior reservoir 50 can be selectively delivered to the vent patch 22 as a pressurized washer fluid PF (see FIG. 5) by the first nozzle 46. The pressurized washer fluid PF is sufficient to wash the vent patch 22 and thus restore proper airflow circulation in and out of the housing 18.

The second nozzle 48 may be operably connected to a fan 54 of the sprayer unit 26. The fan 54 may be housed within an interior cavity 56 of the main housing 44. The fan 54 may be selectively activated to direct an airflow through the second nozzle 48. The second nozzle 48 may direct the airflow onto the vent patch 22 as a pressured airflow PA (see FIG. 5). The pressurized airflow PA may blow off any remaining debris on the vent patch 22 and may further function to dry the vent patch 22.

In an embodiment, during an exemplary cleaning operation of the vent patch cleaning system 24, the first nozzle 46 may operate to deliver the pressurized washer fluid PF to the vent patch 22 first for washing, and then the second nozzle 48 may operate to subsequently deliver the pressurized airflow PA to the vent patch 22 for drying. However, in other exemplary cleaning operations of the vent patch cleaning system 24, the first nozzle 46 may deliver the pressurized washer fluid PF and the second nozzle 48 may deliver the pressurized airflow PA to the vent patch 22 simultaneously or in a reverse order.

The sprayer unit 26 may additionally include an electrical connection 74. The electrical connection 74 may be utilized to operably connect the sprayer unit 26 (and thus the fan 54) to a power source and a communication bus of the vehicle 10, for example.

Referring now primarily to FIG. 5, the vent patch cleaning system 24 may additionally include a sensor system 58 and a controller 60 that are operably connected to one another. The sensor system 58 may include a multitude of sensors arranged and configured for monitoring an interior environment of the lamp assembly 14. In an embodiment, the sensor system 58 includes one or more of a humidity sensor 62, a pressure sensor 64, and/or an airflow sensor 66. The humidity sensor 62, the pressure sensor 64, and the airflow sensor 66 may be mounted to an interior surface of the housing 18, such as for monitoring the interior environment of the lamp assembly 14 for conditions that may indicate the build-up of condensation on the outer lens 20, for example. In other implementations, one or more of the sensors of the sensor system 58 could be mounted directly to the sprayer unit 26, such as on a portion of the mount 30 that extends inside the housing 18, for example.

Although schematically illustrated as a single controller, the controller 60 may be part of a vehicle control system that includes a plurality of additional control modules for interfacing with and commanding operation of the various components of the vent patch cleaning system 24. In an embodiment, the controller 60 is part of a body control module (BCM) of the vehicle 10. However, other configurations are also contemplated within the scope of this disclosure.

The controller 60 may include both hardware and software and may be programmed with executable instructions for interfacing with and commanding operation of various components of the vent patch cleaning system 24 as part of a strategy for automating the cleaning of the vent patch 22. The controller 60 may include a processor 68 and non-transitory memory 70 for executing various control strategies and modes associated with the vent patch cleaning system 24. The processor 68 may be a custom made or a commercially available processor, a central processing unit (CPU), or generally any device for executing software instructions. The memory 70 can include any one or combination of volatile memory elements and/or nonvolatile memory elements. The processor 68 may be operably coupled to the memory 70 and may be configured to execute one or more programs stored in the memory based on various inputs received from other devices associated with the vent patch cleaning system 24, such as inputs from the sensor system 58, for example.

The various subcomponents of the vent patch cleaning system 24 may be interconnected and in electronic communication with one another over one or more communication buses. For example, the pump 38, the sprayer unit 26, and the sensor system 58 of the vent patch cleaning system 24 may be operably connected to the controller 60 over a communication bus 72. In an embodiment, the communication bus 72 is a wired communication bus such as a controller area network (CAN) bus or a local interconnect network (LIN) bus, for example. In another embodiment, the communication bus 72 is a wireless communication bus such as that provided by Wi-Fi, Bluetooth®, Ultra-Wide Band (UWB), etc.

The sensor system 58 may periodically communicate sensor data D to the controller 60. The controller 60 may analyze the sensor data D received from the sensor system 58 for determining whether or not the vent patch 22 requires cleaning. For example, the controller 60 may utilize program logic to determine that the vent patch 22 requires cleaning when the humidity sensed by the humidity sensor 62 exceeds a predefined humidity threshold, when the pressure sensed by the pressure sensor 64 exceeds a predefined pressure threshold, when the airflow detected by the airflow sensor 66 is less than a predefined airflow threshold, or in response to some combination of these and/or other factors for inferring that a level of dirt/debris build-up on the vent patch 22 has been reached.

The controller 60 may be programmed to command the pump 38 to deliver the washer fluid F from the washer fluid reservoir 34 to the sprayer unit 26 after determining that the vent patch 22 requires cleaning. For example, the controller 60 may be programmed to send a first command signal C1 to the pump 38 to cause the pump 38 to deliver the washer fluid F to the interior reservoir 50 of the sprayer unit 26 subsequent to determining that the vent patch 22 requires cleaning. The first nozzle 46 may then deliver the washer fluid F from the interior reservoir 50 onto the vent patch 22 as the pressurized washer fluid PF for washing the vent patch 22 and thus restoring proper airflow circulation in and out of the housing 18.

The controller 60 may additionally be programmed to command activation of the fan 54 after cleaning the vent patch 22 with the pressurized washer fluid PF. For example, the controller 60 may be programmed to send a second command signal C2 to the fan 54 to cause the fan 54 to deliver airflow to the second nozzle 48. The second nozzle 48 may then deliver the pressurized airflow PA to the vent patch 22 for removing any remaining debris and for drying the vent patch 22.

The vent patch cleaning system 24 could be controlled to clean the vent patch 22 in various other manners. For example, the controller 60 may be programmed to activate the pump 38 and/or the fan 54 for initiating the vent patch cleaning operations when the vehicle 10 is either started or tuned off, when a user of the vehicle 10 initiates a command to wash a windshield of the vehicle 10, based off an amount of light output by the lamp assembly 14, etc.

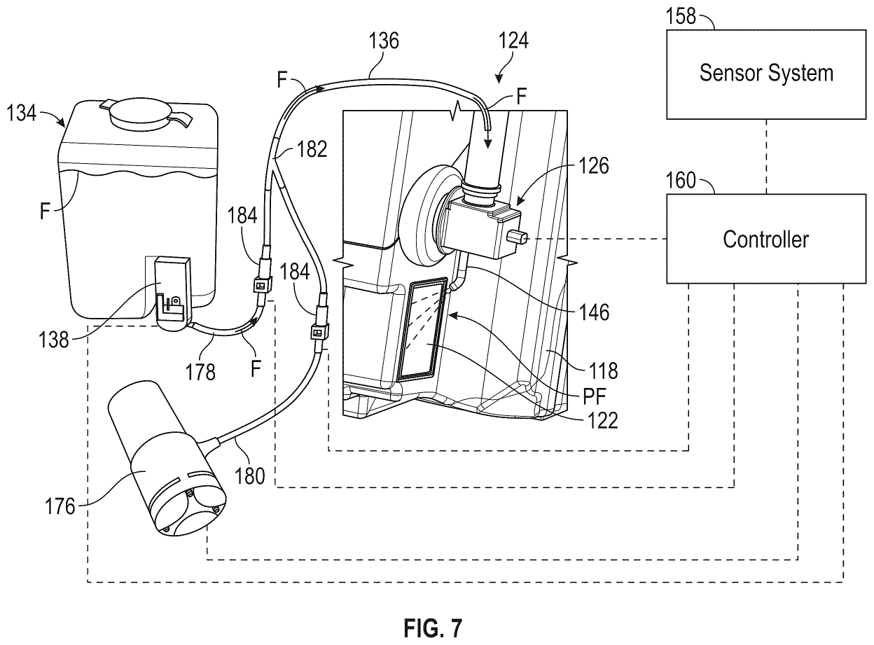

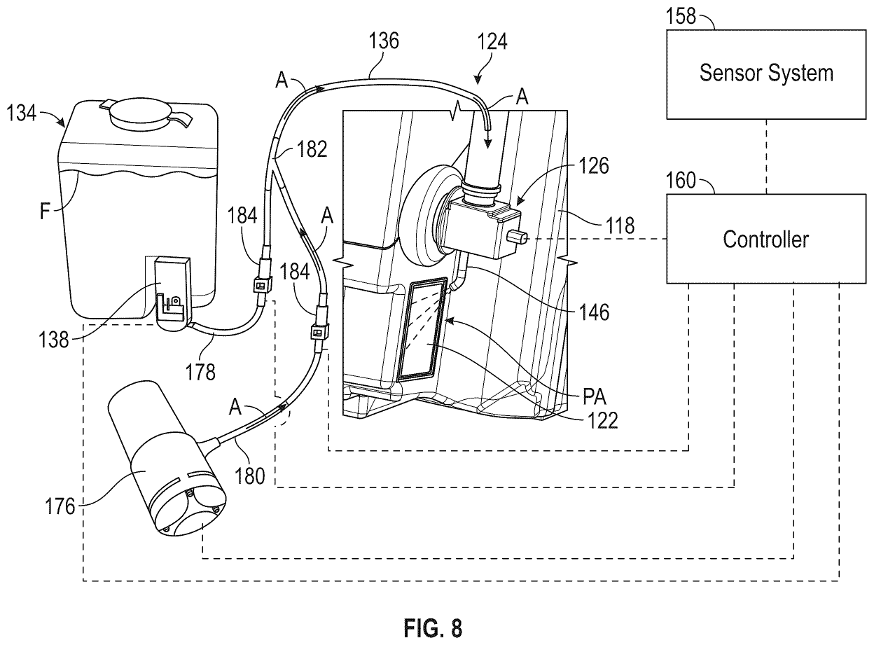

FIGS. 7 and 8 schematically illustrate another exemplary vent patch cleaning system 124 that can be used to clean a vent patch 122 of a vehicle component (e.g., a vehicle lamp assembly). The vent patch cleaning system 124 is similar to the vent patch cleaning system discussed above, however, in this embodiment, the vent patch cleaning system 124 includes a single nozzle arrangement rather than a dual nozzle arrangement for delivering pressurized fluids for selectively cleaning/drying the vent patch 122.

The vent patch cleaning system 124 may include a sprayer unit 126 mounted to a housing 118 of the vehicle component, a washer fluid reservoir 134, an electric air pump 176, a sensor system 158, and a controller 160. The washer fluid reservoir 134 may be fluidly connected to the sprayer unit 126 by a main hose 136 and a first secondary hose 178, and the electric air pump 176 may be fluidly connected to the sprayer unit 126 by the main hose 136 and a second secondary hose 180.

A Y-fitting 182 may fluidly connect the first and second secondary hoses 178, 180 to the main hose 136. The first secondary hose 178 may be connected at one end to a pump 138 of the washer fluid reservoir 134 and at an opposite end to the Y-fitting 182, and the second secondary hose 180 may be connected at one end to the electric air pump 176 and at an opposite end to the Y-fitting 182.

A check valve 184 may be provided within each of the first and second secondary hoses 178, 180 for controlling the flow of fluid originating from either the washer fluid reservoir 134 or the electric air pump 176 into the main hose 136. When activated, the pump 138 may deliver a washer fluid F from the washer fluid reservoir 134 to the sprayer unit 126, and the electric air pump 176, when activated, may deliver an airflow A to the sprayer unit 126. In this implementation, the sprayer unit 126 does not include an internal fan.

The sprayer unit 126 may include a single nozzle 146 that is configured to selectively direct pressurized fluids onto a surface of the vent patch 122 that requires cleaning. Depending on a position of the respective check valves 184, the nozzle 146 may deliver a pressured washer fluid PF (see FIG. 7) or a pressurized airflow PA onto the vent patch 122 (see FIG. 8). The pressurized washer fluid PF is sufficient to wash the vent patch 122 and thus restore proper airflow circulation in and out of the housing 118. The pressurized airflow PA may blow off any remaining debris on the vent patch 122 and may further function to dry the vent patch 122 after it has been cleaned by the pressurized washer fluid PF.

In an exemplary first step of a cleaning operation of the vent patch cleaning system 124 as schematically shown in FIG. 7, the controller 160 may command activation of the pump 138 of the washer fluid reservoir 134, command the check valve 184 of the first secondary hose 178 to an open position, and command the check valve 184 of the second secondary hose 180 to a closed position to deliver washer fluid F to the sprayer unit 126. These commands may be based on feedback the controller 160 has received from the sensor system 158, for example. The nozzle 146 may then deliver the pressurized washer fluid PF to the vent patch 122 for washing the vent patch 122 and thus restoring proper airflow circulation in and out of the housing 118.

In an exemplary second step shown in FIG. 8 that can occur subsequent to the above first step of the cleaning operation, the controller 160 may command activation of the electric air pump 176, command the check valve 184 of the first secondary hose 178 to a closed position, and command the check valve 184 of the second secondary hose 180 to an open position to deliver airflow A from the electric air pump 176 to the sprayer unit 126. These commands may be based on feedback the controller 160 has received from the sensor system 158, for example. The nozzle 146 may then deliver the pressurized airflow PA to the vent patch 122 for removing any remaining debris and for drying the vent patch 122.

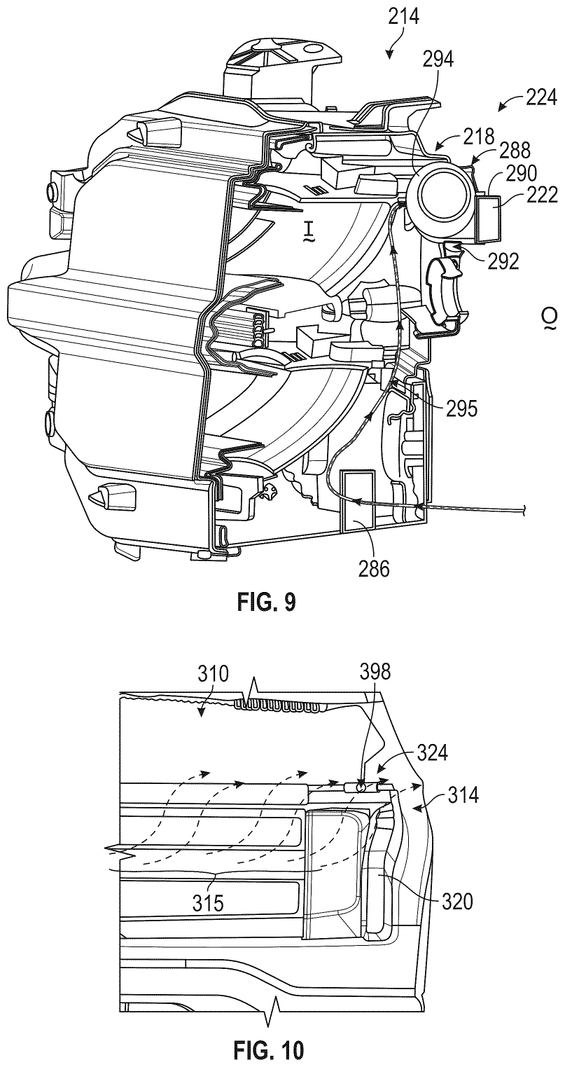

FIG. 9 illustrates another exemplary vent patch cleaning system 224. The vent patch cleaning system 224 may include an air blower 288, a first vent patch 222, and a second vent patch 286. The air blower 288 may be mounted to a housing 218 of a vehicle component 214 (e.g., a vehicle lamp assembly). An outlet 290 of the air blower 288 may be received through an opening 292 formed through the housing 218.

The first vent patch 222 may be mounted to cover the outlet 290 of the air blower 288. The second vent patch 286 may be mounted to the housing 218 at a different location from the air blower 288.

When activated, a blower intake 294 of the air blower 288 can pull air from an interior I of the vehicle component 214 and expel the air through the first vent patch 222 to an outer environment O outside of the vehicle component 214. The air expelled through the first vent patch 222 can clean the first vent patch 222 by removing dirt and debris, for example.

Meanwhile, air can be pulled into the interior I through the second vent patch 286 as a result of a suction force created by the activated air blower 288. The vent patch cleaning system 224 can therefore create an air circulation path (schematically shown at arrow 295) between the interior I and the outer environment O, thereby promoting pressure and environmental equalization and reducing condensation build-up within the interior I.

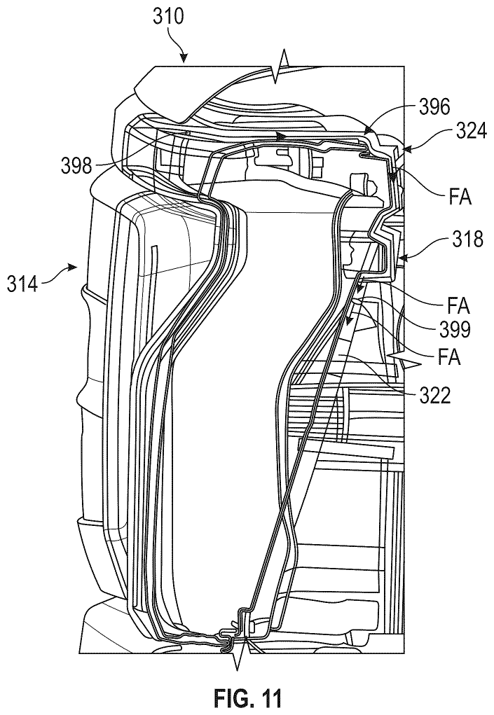

FIGS. 10-11 illustrate yet another exemplary vent patch cleaning system 324. The vent patch cleaning system 324 may include an air duct 396 (see FIG. 11) that is formed (e.g., molded) in a housing 318 of a vehicle component, here illustrated as a lamp assembly 314 of a vehicle 310.

The air duct 396 may extend between an inlet 398 and an outlet 399. The inlet 398 may be located at a front section of the housing 318 that interfaces with an outer lens 320 of the lamp assembly 314. The inlet 398 therefore faces toward the front of the vehicle 310. The outlet 399 may be located at a rear exterior surface of the housing 318. The outlet 399 may be positioned near where a vent patch 322 is mounted to the housing 318.

A forced airflow FA resulting from headwinds 315 that can travel toward the front of the vehicle 310 during its movement may enter the air duct 396 through the inlet 398. The forced airflow FA may then travel through the air duct 396 prior to exiting through the outlet 399. The forced airflow FA exiting the outlet 399 may be directed toward the vent patch 322, thereby blowing dirt and/or other debris off the vent patch 322 and restoring proper airflow circulation through the interior of the lamp assembly 314.

The vehicle vent patch cleaning systems of this disclosure provide dedicated systems for cleaning vent patches of vehicle components. Among other benefits, the vent patch cleaning systems are capable of cleaning and drying vent patches in order to restore air circulation and reduce internal condensation. The proposed systems provide ongoing vent patch maintenance in an automated manner and without any required user input.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A motor vehicle, comprising:
a vehicle component including a vent patch; and
a vent patch cleaning system arranged to selectively direct a fluid toward the vent patch for cleaning the vent patch.

2. The motor vehicle as recited in claim 1, wherein the vehicle component is a lamp assembly of an exterior lighting system of the motor vehicle.

3. The motor vehicle as recited in claim 1, wherein the vent patch cleaning system includes a sprayer unit mounted to a housing of the vehicle component.

4. The motor vehicle as recited in claim 3, wherein the sprayer unit includes a first nozzle arranged to selectively direct a pressurized washer fluid toward the vent patch.

5. The motor vehicle as recited in claim 4, wherein the sprayer unit is fluidly connected to a washer fluid reservoir by a hose.

6. The motor vehicle as recited in claim 4, wherein the sprayer unit includes a second nozzle arranged to selectively direct a pressurized airflow toward the vent patch.

7. The motor vehicle as recited in claim 6, wherein the second nozzle is operably connected to a fan housed inside the sprayer unit.

8. The motor vehicle as recited in claim 1, wherein the vent patch cleaning system includes a sensor system configured to sense a parameter associated with an interior environment of the vehicle component.

9. The motor vehicle as recited in claim 8, comprising a controller operably connected to the sensor system and programmed to selectively command the vent patch cleaning system to direct the fluid toward the vent patch based on sensor data from the sensor system.

10. The motor vehicle as recited in claim 9, wherein the sensor data includes information related to a humidity, an airflow, or a pressure within the interior environment.

11. The motor vehicle as recited in claim 1, wherein the vent patch cleaning system includes a spraying unit, a washer fluid reservoir, and an electric air pump.

12. The motor vehicle as recited in claim 1, wherein the vent patch cleaning system includes an air blower, the vent patch, and a second vent patch.

13. The motor vehicle as recited in claim 1, wherein the vent patch cleaning system includes an air duct formed within a housing of the vehicle component.

14. The motor vehicle as recited in claim 13, wherein the air duct includes an inlet configured to receive a forced airflow extracted from a headwind of the motor vehicle and an outlet configured to direct the forced airflow onto the vent patch.

15. A vent patch cleaning system for a motor vehicle, comprising:
a washer fluid reservoir configured to hold a washer fluid;
a sprayer unit configured to receive the washer fluid from the washer fluid reservoir; and
a first nozzle of the sprayer unit configured to receive the washer fluid and deliver a pressurized washer fluid onto a vent patch for cleaning the vent patch.

16. The vent patch cleaning system as recited in claim 15, wherein a second nozzle of the sprayer unit is configured to deliver a pressurized airflow onto the vent patch for drying the vent patch.

17. The vent patch cleaning system as recited in claim 16, wherein the second nozzle is operably connected to a fan housed inside the sprayer unit.

18. The vent patch cleaning system as recited in claim 17, comprising a sensor system configured to sense a parameter associated with an interior environment of a vehicle component to which the vent patch is attached.

19. The vent patch cleaning system as recited in claim 18, comprising a controller operably connected to the sensor system and programmed to selectively command the vent patch cleaning system to perform a vent patch cleaning operation based on sensor data from the sensor system.

20. The vent patch cleaning system as recited in claim 19, wherein, during a first step of the vent patch cleaning operation, the controller is programmed to command the vent patch cleaning system to direct the pressurized washer fluid onto the vent patch for cleaning the vent patch, and during a second step of the vent patch cleaning operation, the controller is programmed to command the vent patch cleaning system to direct the pressurized airflow onto the vent patch for drying the vent patch.
